(19) United States
(12) Patent Application Publication
(10) Pub. No.: US 2011/0121106 A1
(43) Pub. Date: May 26, 2011

(54) WIND-COLLECTING NOZZLE MOUNTED ON OUTLET OF HAIRDRYER

(76) Inventor: Han Hian Yoe, Guangdong (CN)

(21) Appl. No.: 12/737,575

(22) PCT Filed: Mar. 16, 2010
(86) PCT No.: PCT/CN2010/071084

§ 371 Date: Jan. 26, 2011

(30) Foreign Application Priority Data
Mar. 24, 2009 (CN) 200920135833.3

(51) Int. Cl. B05B 1/14

(52) U.S. Cl. 239/548

(57) ABSTRACT

A wind-collecting nozzle mounted on outlet of hairdryer includes a wind-collecting nozzle body (1), and at least two blowing ports are formed on the nozzle body (1). One end of the nozzle body (1) has a plug-and-pull connector (11) for mounting on the outlet of the dryer (3), and the other end has two spaced mounting ports, wherein a blowing piece (2) is mounted at each of the mounting ports, and the free end of the blowing piece (2) has a flat blowing outlet (21). The mounting ports of the wind-collecting nozzle body (1) are circular ports, and a protruding element is formed on each inner side of the mounting ports. Each blowing piece (2) has a circular shaped opening provided at a mounting end thereof where a ring shaped groove is provided therein for receiving the protruding element therein so as to enable the blowing piece rotating about the respective protruding element. Each of the two blowing outlets is in flat shape and the pair of blowing outlets is arranged in a [symbol] -shaped configuration. The wind-collecting nozzle can improve the effect of quick-drying and can be adjusted according to different situations.

### BACKGROUND OF THE PRESENT INVENTION

1. Field of Invention

The present invention relates to the technical field of hairdressing tool, and more particularly to a wind-collecting nozzle mounted on the outlet of dryer.

2. Description of Related Arts

Currently, after washing the hair, people simply use towels to wipe the hair and let the hair dry naturally. However, in order to dry the hair quickly, a dryer (hairdryer) may be used to dry the hair. Hence, the dryer becomes a very important hairdressing tool in people's living. As the dryer could produce hot air with various temperatures, it can thus be generally applied to various applications. For example, people feed pets and some pets have very long and thick hair, such as the dogs that its hair will get very wet after bathing. It is required to dry its hair and people generally use the dryer for drying it. However, the current dryer generally has installed a wind-collecting nozzle having a flat blowing outlet or a round blowing outlet which fails to provide an ideal effect of quick-drying and a convenient operation.

### SUMMARY OF THE PRESENT INVENTION

An objective of the present invention is to provide a wind-collecting nozzle mounted on a dryer for enhancing the quick-drying effect of the dryer.

Another objective of the present invention is to provide a wind-collecting nozzle which is capable of being adjusted according to different situations so as to achieve a most effective dryer with the fastest drying ability.

In order to accomplish the above objectives, the present invention provides a wind-collecting nozzle mounted on an outlet of a dryer, wherein the wind-collecting nozzle comprises a wind-collecting nozzle body having at least two blowing ports.

In a preferred embodiment, the wind-collecting nozzle provides two blowing ports.

In a preferred embodiment, the wind-collecting nozzle body has a plug-and-pull connector provided at a first end thereof for mounting to the air outlet of the dryer and two mounting ports provided at a second end thereof in a spaced apart manner, wherein each of the mounting ports is provided with a blowing piece having a flat shaped blowing outlet formed at a free end thereof.

Each mounting port of the wind-collecting nozzle body is circular shaped port which has a protruding element formed around the inner side thereof. Each blowing piece has a circular shaped opening provided at a mounting end thereof where a ring shaped groove is provided therein for receiving the protruding element therein so as to enable the blowing piece rotating about the respective protruding element.

Each of the two blowing outlets is in flat shape and the pair of blowing outlets is arranged in a [symbol] -shaped configuration.

In comparison with the prior art, the wind-collecting nozzle of the present invention contains the following advantages.

As the wind-collecting nozzle of the present invention has at least two blowing ports provided in the wind-collecting nozzle body so as to render the dryer becoming a double-outlets or multiple-outlets dryer, so that it can provide a quick-drying effect for the pets with very long and thick hair as well as the human's hair.

As the blowing pieces are capable of rotating about the protruding elements respectively, the two blowing ports are capable of being rotated and adjusted according to different requirements. When the two blowing ports are adjusted to the [symbol] -shaped configuration, the blowing pieces can provide the most effective and fastest drying ability.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a wind-collecting nozzle mounted on the outlet of a dryer according to a preferred embodiment of the present invention.

FIG. 2 is a side view of FIG. 1.

FIG. 3 is a structural view of the wind-collecting nozzle mounted on the outlet of the dryer according to above preferred embodiment of the present invention.

FIG. 4 is a front view of the wind-collecting nozzle mounted on the outlet of the dryer according to above preferred embodiment of the present invention.

FIG. 5 is a front view of the dryer.

### DETAILED DESCRIPTION OF THE PREFERRED EMBODIMENT

The wind-collecting nozzle mounted on the outlet of the dryer of the present invention is further described as follows with the reference to the drawings.

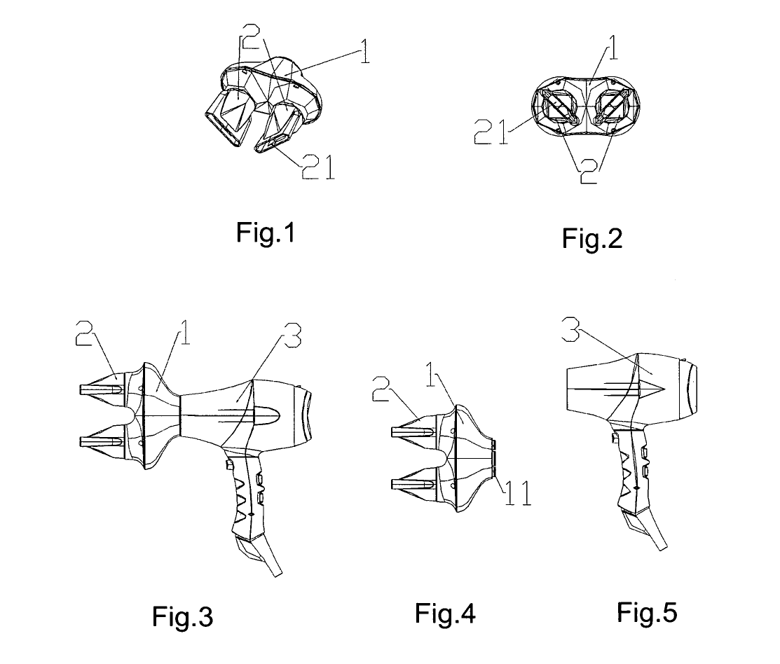

Referring to FIGS. 1-4, the present invention provides a wind-collecting nozzle for mounting on the outlet of a dryer, wherein the wind-collecting nozzle comprises a wind-collecting nozzle body 1. The wind-collecting nozzle body 1 comprises an plug-and-pull connector 11 provided at first end thereof for mounting on the outlet of the dryer 3 and two spacedly disposed mounting ports provided at a second end thereof, wherein each mounting port has a blowing piece 2 having a flat shaped blowing outlet 21 formed at a the free end thereof.

Each mounting port of the wind-collecting nozzle body 1 is circular shaped port which has a protruding element formed around the inner side thereof. Each blowing piece 2 has a circular shaped opening provided at a mounting end thereof where a ring shaped groove is provided therein for receiving the protruding element therein so as to enable the blowing piece rotating about the respective protruding element. When using, the two blowing outlets, each being embodied to have a flat shape, of the wind barrel 2 are preferably adjusted to in a [symbol] -shaped configuration to achieve the most effective and fastest drying ability.

The plug-and-pull connector 11 of the wind-collecting nozzle body 1 is embodied as a circular groove with positioning holes formed therein. Preferably, the wind-collecting nozzle body 1 has a plurality of mounting ports and the blowing pieces 2 and the wind-collecting body 1 could be made integrally with the two flat shaped blowing outlets to be arranged in the [symbol] -shaped configuration.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A wind-collecting nozzle for mounting on an outlet of a dryer, comprising a wind-collecting nozzle body which has at least two blowing outlets provided therein.

2. The wind-collecting nozzle, as recited in claim 1, wherein said wind-collecting nozzle has two blowing outlets.

3. The wind-collecting nozzle, as recited in claim 2, wherein said wind-collecting nozzle body has a plug-and-pull connector provided at a first end thereof and two mounting ports provided at a second end in a spaced apart manner, wherein two blowing pieces are provided at said mounting ports respectively and said blowing outlets are provided at free ends of said blowing pieces respectively.

4. The wind-collecting nozzle, as recited in claim 3, wherein each said mounting port of said wind-collecting nozzle body is circular shaped port which has a protruding element formed around an inner side of said respective round mounting port, and each said blowing piece has a circular shaped opening provided at a mounting end thereof where a ring shaped groove is provided therein for receiving said protruding element therein to enable said blowing piece rotating about said respective protruding element.

5. The wind-collecting nozzle, as recited in claim 2, wherein said two blowing outlets are in flat shaped and arranged in a [symbol] -shaped configuration.
